(19) United States
(12) Patent Application Publication
(10) Pub. No.: US 2024/0095109 A1
(43) Pub. Date: Mar. 21, 2024

(54) ASYNCHRONOUS PREDICTION IN MACHINE LEARNING MODEL SERVING

(71) Applicant: Twitter, Inc., San Francisco, CA (US)

(72) Inventors: Lawrence Lam, San Francisco, CA (US); Di Zhao, San Carlos, CA (US)

(21) Appl. No.: 17/945,960

(22) Filed: Sep. 15, 2022

(51) Int. Cl. G06F 9/54; G06N 20/00

(52) U.S. Cl. CPC G06F 9/547; G06N 20/00

(57) ABSTRACT

Example computer-implemented methods, media, and systems for serving machine learning (ML) models using an asynchronous input/output (I/O) mechanism are disclosed. One example method includes receiving a first request for running a ML model to provide a first prediction. A first green thread is generated responsive to the first request and executed on an operating system (OS) thread to send a first asynchronous remote procedure call (RPC) to a multiple producer single consumer (MPSC) channel. A second request for running the ML model to provide a second prediction is received. A second green thread is generated responsive to the second request and executed on the OS thread to send a second RPC to the MPSC channel. The first and the second asynchronous RPCs are scheduled using a first and a second blocking threads respectively, which are used by the ML model to generate the first prediction and the second prediction.

### BACKGROUND

Machine learning (ML) model serving can be used in many applications to serve requests from trained ML models in production. The ML model generates predictions responsive to received requests based on the trained parameters of the model, which can then be used, for example, to classify content or to provide particular recommendations. The ML model can be hosted on one or more ML model serving platforms configured to receive requests from different services. Some of the applications serve predictions at a large scale, for example, at millions of queries per second (QPS), while meeting stringent latency requirements. Computational cost associated with serving predictions in production can be high given the large number of QPS.

### BRIEF DESCRIPTION OF DRAWINGS

FIG. 1 depicts an example thread based ML serving model.

FIG. 2 depicts an example request serving architecture.

FIG. 3 depicts an example process for serving ML model requests.

FIG. 4 is a schematic illustration of example computer systems that can be used to execute implementations of the present disclosure.

Like reference numbers and designations in the various drawings indicate like elements.

### SUMMARY

This specification is generally directed to computer-implemented methods, computer storage media, and systems for serving ML models using an asynchronous input/output (I/O) mechanism while reusing a collection of operating system (OS) threads for handling multiple asynchronous request calls. One example method includes receiving multiple requests for running a trained ML model hosted on a ML model serving platform to provide predictions based on parameters associated with each request. The received multiple requests are used to generate multiple asynchronous remote procedure calls (RPCs), each of which is mapped to a respective asynchronous remote procedure call (RPC) non-blocking thread. A collection of OS threads can be reused to execute the asynchronous RPC non-blocking threads to submit the multiple asynchronous RPCs to a multiple producer single consumer (MPSC) channel. The multiple asynchronous RPCs in the MPSC channel are retrieved by a single threaded lock free scheduler and the parameters in the multiple RPCs are submitted to multiple blocking threads, which are used by the trained ML model to generate predictions for the multiple requests.

The subject matter described in this specification can be implemented in particular embodiments so as to realize one or more of the following advantages. Batch processing of model serving requests can be used in ML model serving to improve the efficiency of inferencing in ML. The computational cost of batch processing of the multiple requests can be lowered using asynchronous I/O mechanism because the computational cost associated with waiting for I/O intensive workloads can be reduced. Zero copy can be implemented as pointer swap so that no additional copy of data is needed when a ML model hosted on a ML model serving platform is called to generate a prediction based on the data. Garbage collection (GC) can also be eliminated by using a programming language that favors stack-based memory allocation over heap-based memory allocation. Eliminating GC can reduce long tail latency.

It is appreciated that methods in accordance with the present disclosure can include any combination of the aspects and features described herein. That is, for example, apparatus and methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description, drawings, and claims.

Implementations of the present disclosure are described in further detail herein with reference to an example use case. The example use case includes using an asynchronous I/O library with a ML model serving platform hosting a ML model to reuse a thread for handling multiple asynchronous request calls. It is contemplated, however, that implementations of the present disclosure can be realized with any appropriate use case.

### DETAILED DESCRIPTION

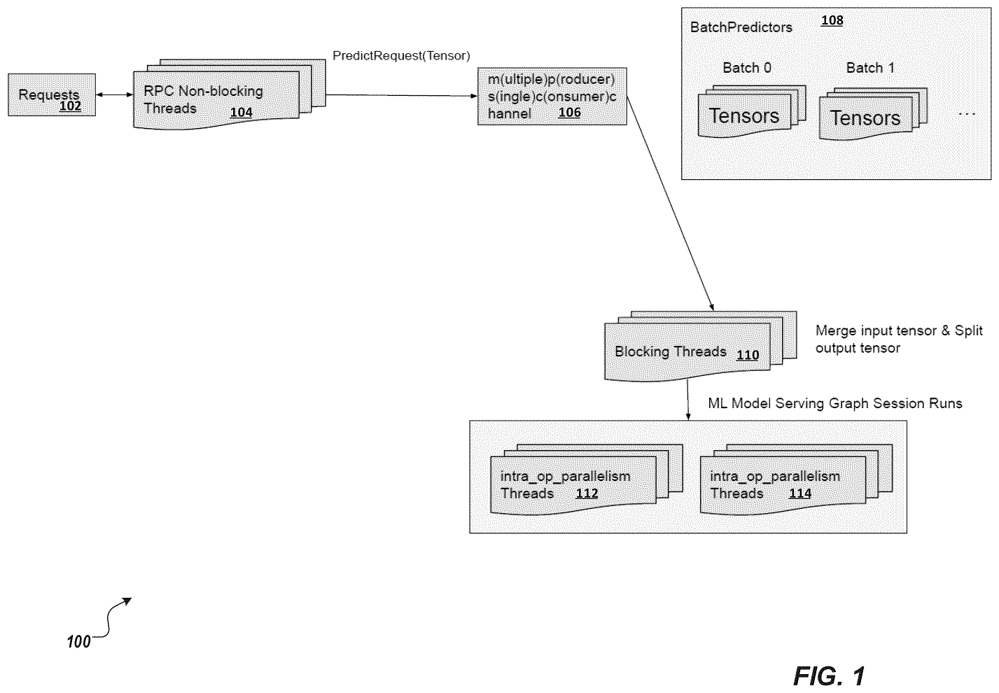

FIG. 1 depicts an example thread based ML serving model 100. In some implementations, thread based ML serving model 100 can be used to provide a way to efficiently serve a large number of requests to a ML model hosted on a ML model serving platform, using an asynchronous input/output (I/O) mechanism, for example, asynchronous remote procedure calls (RPCs), and the ML model can then generate one or more predictions in response to each request from thread based ML serving model 100. Requests 102 can include multiple requests with each request requesting a prediction from the ML model hosted on the ML model serving platform. Each request can include a corresponding tensor that includes multiple parameters that can be used by the ML model to generate the prediction.

An example of the ML model serving platform is TensorFlow™, an open-source software library for machine learning and artificial intelligence. TensorFlow™ is a trademark of Google, LLC. An example of the prediction is a prediction of particular content that the user of a social messaging platform is likely to engage with when presented to a user. For example, based on the predication, a social messaging platform can determine a recommended content item to add to a message stream associated with a particular user account.

In some implementations, remote procedure call (RPC) non-blocking threads 104 are generated based on requests 102. For example, when a request in requests 102 is received, a RPC non-blocking thread, also called a green thread, is spawned correspondingly. The green thread is executed on a pre-spawned OS thread and set to wait status once the RPC request is submitted to an internal queue. The OS thread is freed afterwards to carry out other activities from other green threads. Multiple non-blocking threads can be multiplexed into one OS thread in this way, avoiding OS level context switch and scheduling. Because the logic happens at user space rather than kernel space, system calls can be avoided. RPC non-blocking threads 104 can include multiple threads, with each thread mapped to an OS thread. Because each OS thread can be reused for multiple RPC non-blocking threads, a very limited number of OS threads can be used to handle a large number of requests in requests 102. One example is to use 8 OS threads to handle 7000 queries per second (QPS). The remote procedure calls (RPCs) associated with threads 104 are asynchronous RPCs. RPC can be a request-response protocol initiated by a client, which can send a request message to a remote server to execute a procedure with supplied parameters. The remote server can then send a response to the client. In some implementations, a runtime library is used to schedule the green threads.

In some implementations, cooperative multitasking can be used by the runtime library, where context switching from a running thread to another thread is rarely initiated, and the role of the runtime library can be limited to starting the threads and letting them return control back to it voluntarily. Context switching can be a process of storing the state of a thread, so that the state can be restored and resume execution at a later point, and then restoring a different, previously saved, state.

In some implementations, multiple producer single consumer (MPSC) channel 106 stores multiple RPCs, for example, PredictRequest(tensor). MPSC channel 106 can have multiple senders and one receiver, and can be used for communicating between asynchronous green threads.

In some implementations, a batch prediction scheduler can be used to poll MPSC channel 106 to retrieve RPCs such as PredictRequest(tensor) stored in MPSC channel 106. The scheduler can be a single threaded scheduler to enable lock free scheduling of tensors to be assigned to threads. The single tensor in each retrieved PredictRequest is then extracted from the retrieved PredictRequest and put into a tensor batch, such as batch 0 or batch 1 in BatchPredictors 108. Each of batch 0 and Batch 1 can have multiple extracted tensors. Zero copy can be implemented for the use of the tensor batch. When forming the tensor batch, the actual content of a tensor in the tensor batch is not copied. Instead the tensor batch only records the memory address of each individual tensor. By using zero copy no additional copy of each extracted tensor is needed when the ML model hosted on the ML model serving platform is called to generate the prediction based on each extracted tensor.

In some implementations, messaging passing can be used by the scheduler, where the scheduler sends a message to a thread and then relies on the thread and its supporting infrastructure to select and run appropriate code.

In some implementations, the tensor batch is submitted by the scheduler to a set of blocking threads 110. When a blocking thread enters a section of code or method that can only be executed by one thread at a time, that blocking thread locks the section of code. Therefore other threads must wait until the blocking thread leaves that section of code. When a thread has the code locked, it's called a blocking thread because it is blocking other threads from executing the code. If the ML model serving platform runtime does not support asynchronous I/O, blocking threads 110 can be sent to the runtime of the ML model serving platform in order to run the ML model hosted on the ML model serving platform for the generation of a respective prediction based on each thread in blocking threads 110. An example can be running the graph session of TensorFlow™ for batch inferencing, where each graph session includes data structures that contain a set of operations and a set of tensors in TensorFlow™. The set of operations can represent a set of units of computation in TensorFlow™, and the set of tensors can represent a set of units of data that flow between operations. When running the ML model based on threads in blocking threads 110, part of the threads, for example, intra_op_parallelism threads 112, can be used within an individual operation for parallelism, and part of the threads, for example, inter_op_parallelism threads 114, can be used for parallelism between independent operations.

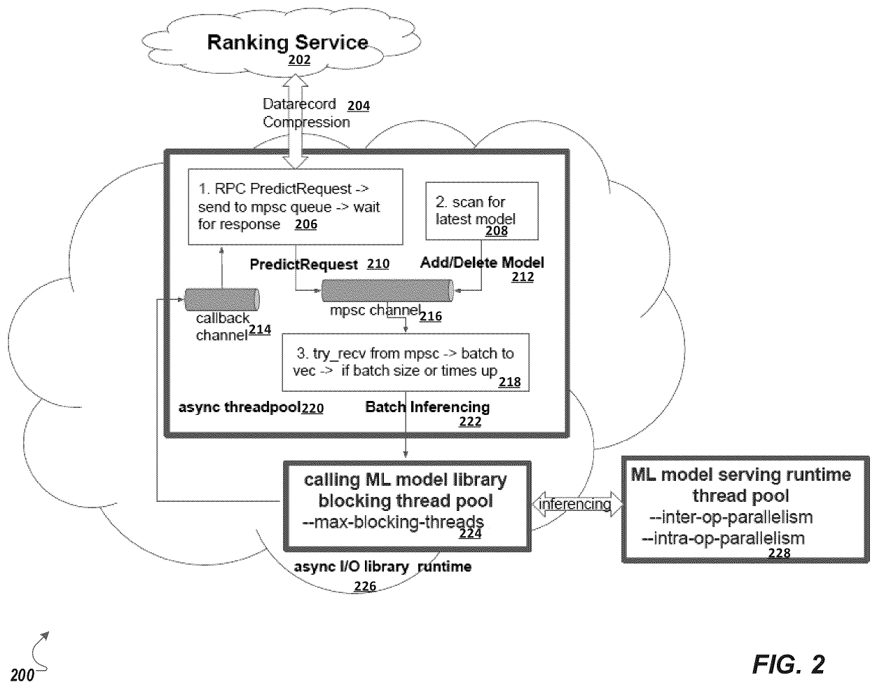

FIG. 2 depicts an example request serving architecture 200. In some implementations, example architecture 200 can be used to implement the example thread model 100 depicted in FIG. 1. A client, such as ranking service 202, can send a request for a prediction to asynchronous I/O library runtime 226. The request can be compressed at data record compression 204 before being sent to asynchronous I/O library runtime 226.

For example, the ranking service 202 can be part of a social messaging platform. The ranking service 202 can receive requests for content to include in a message stream associated with particular user accounts. The requests can be generated by the messaging platform in response to various criteria. The ranking service 202 can further receive one or more model predictions in response to each request. The model predictions in this context can comprise message identifiers for content items having associated probabilities. The ranking service 202 can select particular content items to add to a message stream of a particular user account based on the predictions and any other suitable ranking criteria. For example, the probability can indicate a likelihood of engagement with the content item when viewed by a particular user. The recommendation can be a sponsored message that is then added to the message stream. Messages in the stream can further be ranked to determine a presentation order in response to a request by the corresponding user account.

At 206, the received request is used to generate an asynchronous request call, for example, RPC PredictRequest 210, in asynchronous I/O library runtime 226. An example of asynchronous I/O library runtime 226 is the runtime for Tokio™, an asynchronous I/O library based on Rust programming language. RPC PredictRequest 210 includes a tensor that represents multiple parameters that can be used by a ML model hosted on a ML model serving platform, for example, TensorFlow™, to generate the prediction. PRC PredictRequest 210 is then sent to MPSC channel 216 for further processing. In some implementations, one PRC PredictRequest is mapped to an asynchronous RPC “green thread”. A green thread can refer to a representation of an instance of suspendable and resumable computation. It is conceptually similar to a thread, in the sense that it takes a block of code to run work concurrently with the rest of the code. However, a green thread is not bound to any particular OS thread. A user space scheduler can be used to schedule multiple green threads in one OS thread. The user space scheduler can use epoll system calls in an operating system, for example, Linux®, to receive network and other event notifications asynchronously in user space. The user space scheduler can then use a work-stealing algorithm to improve CPU usage. With the user space scheduler, a handful OS threads can handle thousands of asynchronous RPC green threads concurrently, this approach can scale QPS to a high level. Staying in user space can also avoid system calls into OS kernel space. Callback channel 214 can be used to send single values across asynchronous green threads. Callback channel 214 can be used for an inference thread, which is different from the asynchronous RPC non-blocking thread, to send back the prediction result to an asynchronous RPC non-blocking thread. Callback channel 214 is implemented using asynchronous event notifications described above, which can be more efficient than using OS thread wait/notification semantics.

At 208, a scan is performed to find the latest model for the ML model. This ensures that the request is submitted to the most up-to-date version of the ML model.

At 212, if the latest model is found to be different from the ML model hosted in the ML model serving platform, the latest model is sent MPSC channel 216 to update the ML model hosted on the ML model serving platform.

At 218, a batch prediction scheduler can be used to poll MPSC channel 216 to retrieve asynchronous RPCs such as RPC PredictRequest 210 stored in MPSC channel 216. The scheduler can be a single threaded scheduler to enable lock free scheduling of asynchronous request calls retrieved from MPSC channel 216. In some implementations, a single-threaded loop can be set up as part of the scheduler to retrieve all the asynchronous RPCs in MPSC channel 216. Having only one thread in the loop can make metadata CPU cache friendly, and therefore expedite the processing and make the code logic simple. The single tensor in each retrieved request is then extracted from the retrieved request and put into a tensor batch. The tensor batch can have multiple extracted tensors. When the number of extracted tensors in the batch reaches a predefined threshold or when a predefined period of time has passed since the last tensor batch was submitted by the scheduler to a set of blocking threads, the tensor batch is submitted by the scheduler to the set of blocking threads for batch inferencing in the ML model serving platform. Each OS thread used to handle multiple asynchronous RPC non-blocking threads can be from asynchronous thread pool 220.

In some implementations, steps 206 and 218 can be repeated for another request received from ranking service 202, and a single OS thread can be used by the user space scheduler to handle multiple asynchronous RPCs stored in MPSC channel 216.

At 222, batch inferencing based on the set of blocking threads is initiated.

At 224, the ML libraries in the ML model serving platform are called to run the ML model based on the set of blocking threads, in order to generate a set of predictions, with each prediction corresponding to a request from ranking service 202.

At 228, the runtime of the ML model serving platform is executed with a thread pool containing both threads that can be used within an individual operation for parallelism, for example, intra_op_parallelism, and threads that can be used for parallelism between independent operations, for example, inter_op_parallelism. The predictions generated by the ML model for each request from ranking service 202 are then provided to ranking service 202.

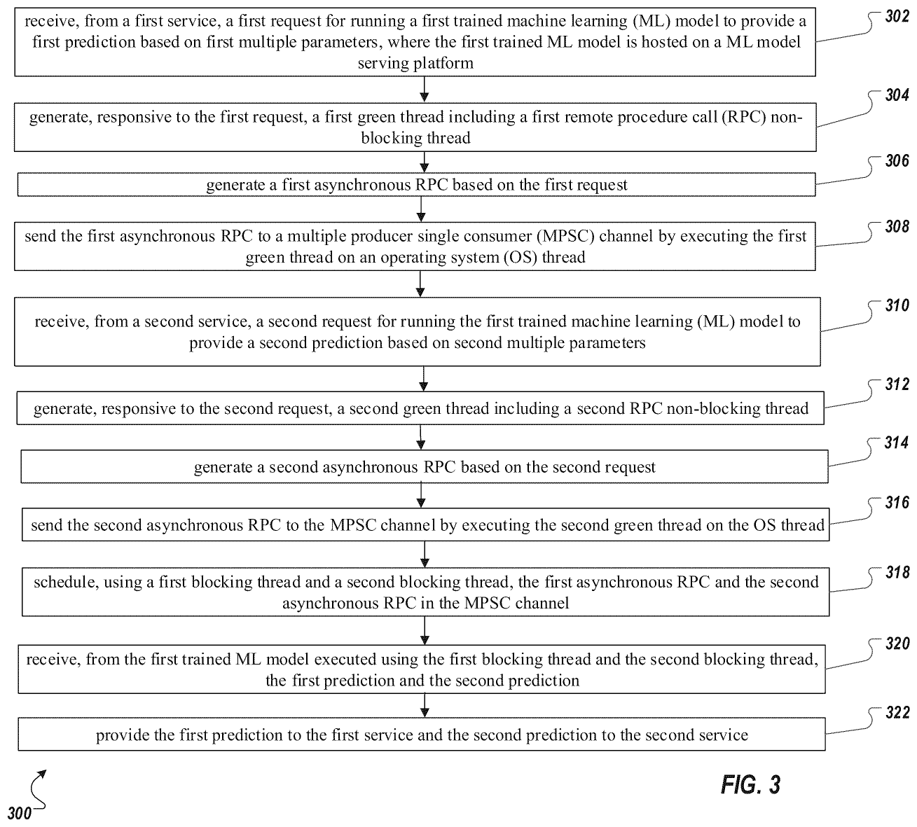

FIG. 3 depicts an example process 300 for serving ML model requests. For convenience, the process 300 will be described as being performed by a system of one or more computers, located in one or more locations, and programmed appropriately in accordance with this specification. For example, a request serving system, e.g., the request serving system as provided by architecture 200 of FIG. 2, appropriately programmed, can perform the process 300.

At 302, a computer system receives, from a first service, a first request for running a first trained machine learning (ML) model to provide a first prediction based on first multiple parameters, where the first trained ML model is hosted on a ML model serving platform.

At 304, the computer system generates, responsive to the first request, a first green thread including a first remote procedure call (RPC) non-blocking thread.

At 306, the computer system generates a first asynchronous RPC based on the first request.

At 308, the computer system sends the first asynchronous RPC to a multiple producer single consumer (MPSC) channel by executing the first green thread on an operating system (OS) thread.

At 310, the computer system receives, from a second service, a second request for running the first trained machine learning (ML) model to provide a second prediction based on second multiple parameters.

At 312, the computer system generates, responsive to the second request, a second green thread including a second RPC non-blocking thread.

At 314, the computer system generates a second asynchronous RPC based on the second request.

At 316, the computer system sends the second asynchronous RPC to the MPSC channel by executing the second green thread on the OS thread.

At 318, the computer system schedules, using a first blocking thread and a second blocking thread, the first asynchronous RPC and the second asynchronous RPC in the MPSC channel.

At 320, the computer system receives, from the first trained ML model executed using the first blocking thread and the second blocking thread, the first prediction and the second prediction.

At 322, the computer system provides the first prediction to the first service and the second prediction to the second service.

A social messaging platform is described next as a use case of a messaging system. Social messaging platforms can have large numbers of users interacting with the platform at any given time. Sponsored messages or other recommended content can be provided to users by adding messages to the message stream of user accounts. At any given point in time there can be a very large number of requests that need to be served to a prediction model within a short latency period. The thread based ML serving model described above allows for large numbers of content requests to be efficiently submitted to the ML model.

The content request can include an identifier of the target user account. The ML model can be trained to generate a content prediction for that particular user account. For example, the ML model can be trained based on a collection of data associated with accounts of the platform including demographic information, user interests and/or other profile information, user engagement history, and user relationships with other accounts for a collection of user accounts. For an input request including an identifying account, the ML model generates one or more predictions for content items that can be provided to the message stream of the user account responsive to the request based on information about the particular user account input into the model including, for example, demographic information, user interests, and user engagement history for the particular user account. The predictions can indicate content items in which the user is most likely to engage.

A social messaging platform may have many millions of accounts, and anywhere from hundreds of thousands to millions of connections may be established or in use between clients and the platform at any given moment. The accounts may be accounts of individuals, businesses, or other entities, including, e.g., pseudonym accounts, novelty accounts, and so on.

The platform and client software can be configured to enable users to draft messages and to use the platform, over data communication networks, to post messages to the platform and to receive messages posted by other users. The platform and client software can be configured to enable users to post other kinds of content, e.g., image, video, or audio content, or a combination of kinds of content, either separately or combined with text messages.

Optionally, the platform can be configured to enable users to define immediate or scheduled sessions with individual or groups of users for audio or audio and video interactions. The platform can enable users to specify participation in such sessions using the relationships defined, for example, in the connection graphs maintained by the platform.

The platform can be configured to deliver content, generally messages, to users in their home feed stream. The messages can generally include messages from accounts the user is following, meaning that the recipient account has registered to receive messages posted by the followed account. The platform can also include messages that the platform determines are likely to be of interest to the recipient, e.g., messages on topics of particular current interest, as represented by the number of messages on the topics posted by platform users, or messages posted on topics of apparent interest to the recipient, as represented by messages the recipient has posted or engaged with, or messages on topics the recipient has expressly identified to the platform as being of interest to the recipient, as well as selected advertisements, public service announcements, promoted content, or the like.

The platform can enable users to send messages directly to one or more other users of the platform, allowing the sender and recipients to have a private exchange of messages. The platform can be configured with interfaces through which a client can post messages directed to other users, both synchronously and asynchronously. Thus, users are able to exchange messages in real-time, i.e., with a minimal delay, creating what are essentially live conversations, or to respond to messages posted earlier, on the order of hours or days or even longer.

The platform can also index content items and access data that characterizes users' access to content. The platform provides interfaces that enable users to use their clients to search for users, content items, and other entities on the platform.

A message posted on the platform can contain data representing content provided or selected by the author of the message. The message may be an instance of a container data type storing the content data. The types of data that may be stored in a message can include text, graphics, images, video, and computer code, e.g., uniform resource locators (URLs), for example. Messages can also include key phrases, e.g., hashtags, that can aid in categorizing messages or in linking messages to topics. Messages can also include metadata that may or may not be editable by the message author or account holder, depending on what the platform permits. Examples of message metadata include a time and date of authorship and a geographical location of the user device when the client posted the message. In some implementations, what metadata is provided to the platform by a client is determined by privacy settings controlled by the user or the account holder.

Messages composed by one account holder may include references to other accounts, other messages, or both. For example, a message may be composed in reply to another message posted by another account or by the user. Messages may also be republications of messages received from another account. An account referenced in a message may appear as visible content in the message, e.g., as the name of the account, and may also appear as metadata in the message. As a result, the referenced accounts can be interactive in the platform. For example, users may interact with account names that appear in their message stream to navigate to message streams of those accounts. The platform can also allow users to designate particular messages as private; a private message will only appear in the message streams of the composing and recipient accounts.

Generally, messages on the platform are microblog posts, which differ from email messages in a number of ways, for example, in that an author of the post does not necessarily need to specify, or even know, which accounts the platform will select to provide the message to.

A stream can be an ordered collection of messages on the platform that meet one or more stream criteria. A stream can be defined by the stream criteria to include messages posted by one or more accounts. For example, the contents of a stream for a requesting account holder may include one or more of (i) messages composed by that account holder, (ii) messages composed by the other accounts that the requested account holder follows, (iii) messages authored by other accounts that reference the requested account holder, or (iv) messages sponsored by third parties for inclusion in the account holder's message stream. The messages of a stream may be ordered chronologically by time and date of authorship, or reverse chronologically. Streams may also be ordered in other ways, e.g., according to a computationally predicted relevance to the requesting account holder, or according to some combination of time and relevance score.

A stream may potentially include a large number of messages. For both processing efficiency and the requesting account holder's viewing convenience, the platform can identify a subset of messages meeting the stream criteria to send to a requesting client once the stream is generated. The remainder of the messages in the stream are maintained in a stream repository and some or all of the remainder are sent in response to subsequent client requests.

The platform can record user engagements with messages and maintains, in a message repository, data that describes and represents at least a collection of recent messages as well as the engagements with the messages.

Engagement data relative to messages can include data representing user activity with respect to messages. Examples of engagement by a user with a message include reposting the message, marking the message to indicate it is a favorite of, liked by, or endorsed by the user, responding to the message, responding to a message with a response having a sentiment determined by the platform to be positive or negative, quoting the message with further comments, and mentioning or referencing the message.

Engagement data relative to accounts can include data representing connections between accounts. Examples of engagements by a user with respect to an account include aggregated measures of engagement with messages authored by the account. Other examples include how many followers and followees the account has, i.e., how many other accounts are following the account and how many other accounts the account is following. Other examples include measures of similarity between the groups of followers, the groups of followees, or both, of two accounts, including non-account followees.

Data about engagements can be represented on the platform as graphs with connections between accounts and messages, and stored in a graph repository.

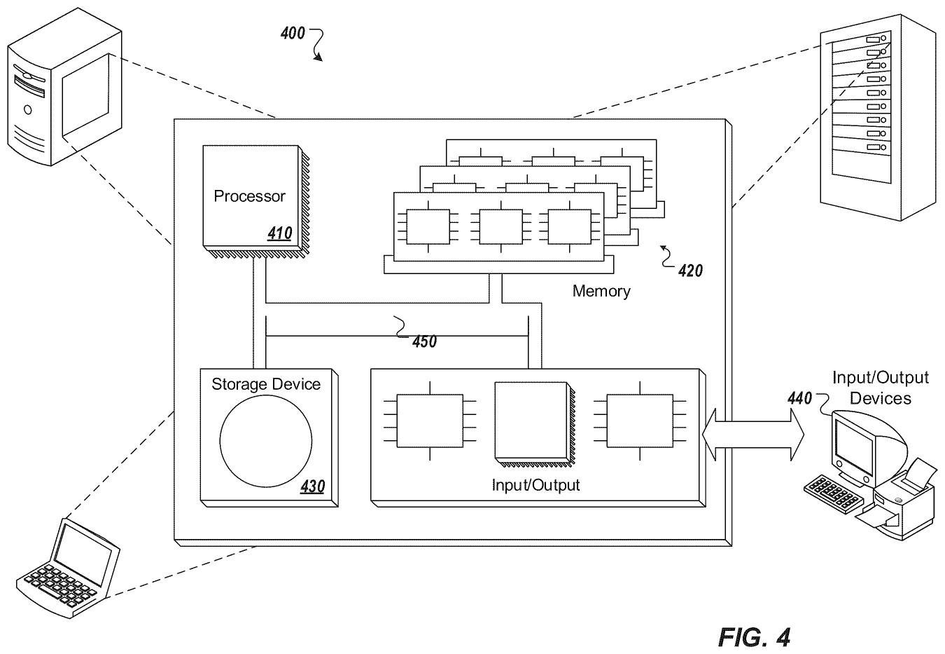

FIG. 4 illustrates a schematic diagram of an example computing system 400. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, and 440 are interconnected using a system bus 450. The processor 410 is capable of processing instructions for execution within the system 400. In some implementations, the processor 410 is a single-threaded processor. The processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. The memory 420 is a volatile memory unit. The memory 420 is a non-volatile memory unit. The storage device 430 is capable of providing mass storage for the system 400. The storage device 430 is a computer-readable medium. The storage device 430 may be a floppy disk device, a hard disk device, an optical disk device, or a tape device. The input/output device 440 provides input/output operations for the system 400. The input/output device 440 includes a keyboard and/or pointing device. The input/output device 440 includes a display unit for displaying graphical user interfaces.

In addition to the embodiments of the attached claims and the embodiments described above, the following embodiments are also innovative:

Embodiment 1 is a computer-implemented method comprising: A first request is received from a first service for running a first trained machine learning (ML) model to provide a first prediction based on first multiple parameters, where the first trained ML model is hosted on a ML model serving platform. A first green thread including a first remote procedure call (RPC) non-blocking thread is generated responsive to the first request. A first asynchronous RPC is generated based on the first request. The first asynchronous RPC is sent to a multiple producer single consumer (MPSC) channel through the execution of the first green thread on an operating system (OS) thread. A second request is received from a second service for running the first trained ML model to provide a second prediction based on second multiple parameters. A second green thread including a second RPC non-blocking thread is generated responsive to the second request. A second asynchronous RPC is generated based on the second request. The second asynchronous RPC is sent to the MPSC channel through the execution of the second green thread on the OS thread. The first asynchronous RPC and the second asynchronous RPC in the MPSC channel are scheduled using a first blocking thread and a second blocking thread. The first prediction and the second prediction are received from the first trained ML model executed using the first blocking thread and the second blocking thread. The first prediction is provided to the first service and the second prediction is provided to the second service.

Embodiment 2 is the method of embodiment 1, wherein scheduling the first asynchronous RPC and the second asynchronous RPC includes retrieving the first asynchronous RPC and the second asynchronous RPC from the MPSC channel, extracting the first multiple parameters from the retrieved first asynchronous RPC and the second multiple parameters from the retrieved second asynchronous RPC, and submitting the extracted first multiple parameters to the first blocking thread and the extracted second multiple parameters to the second blocking thread.

Embodiment 3 is the method of any one of embodiments 1 through 2, further comprising: before receiving the first prediction and the second prediction from the first trained ML model, determining that a second trained ML model is available for generating the first prediction and the second prediction, and sending the second trained ML model to the MPSC channel for the first trained ML model hosted on the ML model serving platform to be updated based on the second trained ML model in the MPSC channel.

Embodiment 4 is the method of any one of embodiments 1 through 3, further comprising: after scheduling the first asynchronous RPC and the second asynchronous RPC and before receiving the first prediction and the second prediction, initiating inferencing of the first prediction and the second prediction in the ML model serving platform by sending the first blocking thread and the second blocking thread to a runtime of the ML model serving platform.

Embodiment 5 is the method of any one of embodiments 1 through 4, wherein the ML model serving platform includes multiple ML libraries.

Embodiment 6 is the method of any one of embodiments 1 through 5, further comprising: after sending the first asynchronous RPC to the MPSC channel and before executing the second green thread on the OS thread, setting the first green thread to wait status, and freeing the OS thread.

Embodiment 7 is the method of embodiment 2, wherein retrieving the first asynchronous RPC and the second asynchronous RPC from the MPSC channel includes retrieving the first asynchronous RPC and the second asynchronous RPC from the MPSC channel using a single-threaded loop, where the single-threaded loop includes one thread for retrieving the first asynchronous RPC and the second asynchronous RPC from the MPSC channel.

Embodiment 8 is a non-transitory computer-readable medium storing instructions which, when executed by a hardware-based processor perform operations including the methods of any one of embodiments 1 to 7.

Embodiment 9 is a computer-implemented system that includes one or more processors including a hardware-based processor, and a memory storage including a non-transitory computer-readable medium storing instructions which, when executed by the one or more processors performs operations including the methods of any one of embodiments 1 to 7.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method comprising:
receiving, from a first service, a first request for running a first trained machine learning (ML) model to provide a first prediction based on a first plurality of parameters, wherein the first trained ML model is hosted on a ML model serving platform;
generating, responsive to the first request, a first green thread comprising a first remote procedure call (RPC) non-blocking thread;
generating a first asynchronous RPC based on the first request;
sending the first asynchronous RPC to a multiple producer single consumer (MPSC) channel by executing the first green thread on an operating system (OS) thread;
receiving, from a second service, a second request for running the first trained ML model to provide a second prediction based on a second plurality of parameters;
generating, responsive to the second request, a second green thread comprising a second RPC non-blocking thread;
generating a second asynchronous RPC based on the second request;
sending the second asynchronous RPC to the MPSC channel by executing the second green thread on the OS thread;
scheduling, using a first blocking thread and a second blocking thread, the first asynchronous RPC and the second asynchronous RPC;
receiving, from the first trained ML model executed using the first blocking thread and the second blocking thread, the first prediction and the second prediction; and
providing the first prediction to the first service and the second prediction to the second service.

2. The computer-implemented method of claim 1, wherein scheduling the first asynchronous RPC and the second asynchronous RPC comprises:
retrieving the first asynchronous RPC and the second asynchronous RPC from the MPSC channel;
extracting the first plurality of parameters from the retrieved first asynchronous RPC and the second plurality of parameters from the retrieved second asynchronous RPC; and
submitting the extracted first plurality of parameters to the first blocking thread and the extracted second plurality of parameters to the second blocking thread.

3. The computer-implemented method of claim 1, wherein before receiving the first prediction and the second prediction from the first trained ML model, the method further comprises:
determining that a second trained ML model is available for generating the first prediction and the second prediction; and
sending the second trained ML model to the MPSC channel for the first trained ML model hosted on the ML model serving platform to be updated based on the second trained ML model in the MPSC channel.

4. The computer-implemented method of claim 1, wherein after scheduling the first asynchronous RPC and the second asynchronous RPC and before receiving the first prediction and the second prediction, the method further comprises:
initiating inferencing of the first prediction and the second prediction in the ML model serving platform by sending the first blocking thread and the second blocking thread to a runtime of the ML model serving platform.

5. The computer-implemented method of claim 1, wherein the ML model serving platform comprises a plurality of ML libraries.

6. The computer-implemented method of claim 1, wherein after sending the first asynchronous RPC to the MPSC channel and before executing the second green thread on the OS thread, the method further comprises:
setting the first green thread to wait status; and
freeing the OS thread.

7. The computer-implemented method of claim 2, wherein retrieving the first asynchronous RPC and the second asynchronous RPC from the MPSC channel comprises retrieving the first asynchronous RPC and the second asynchronous RPC from the MPSC channel using a single-threaded loop, wherein the single-threaded loop comprises one thread for retrieving the first asynchronous RPC and the second asynchronous RPC from the MPSC channel.

8. A non-transitory, computer-readable medium storing one or more instructions executable by a computer system to perform operations comprising:
receiving, from a first service, a first request for running a first trained machine learning (ML) model to provide a first prediction based on a first plurality of parameters, wherein the first trained ML model is hosted on a ML model serving platform;
generating, responsive to the first request, a first green thread comprising a first remote procedure call (RPC) non-blocking thread;
generating a first asynchronous RPC based on the first request;
sending the first asynchronous RPC to a multiple producer single consumer (MPSC) channel by executing the first green thread on an operating system (OS) thread;
receiving, from a second service, a second request for running the first trained ML model to provide a second prediction based on a second plurality of parameters;
generating, responsive to the second request, a second green thread comprising a second RPC non-blocking thread;
generating a second asynchronous RPC based on the second request;
sending the second asynchronous RPC to the MPSC channel by executing the second green thread on the OS thread;
scheduling, using a first blocking thread and a second blocking thread, the first asynchronous RPC and the second asynchronous RPC;
receiving, from the first trained ML model executed using the first blocking thread and the second blocking thread, the first prediction and the second prediction; and
providing the first prediction to the first service and the second prediction to the second service.

9. The non-transitory, computer-readable medium of claim 8, wherein scheduling the first asynchronous RPC and the second asynchronous RPC comprises:
retrieving the first asynchronous RPC and the second asynchronous RPC from the MPSC channel;
extracting the first plurality of parameters from the retrieved first asynchronous RPC and the second plurality of parameters from the retrieved second asynchronous RPC; and
submitting the extracted first plurality of parameters to the first blocking thread and the extracted second plurality of parameters to the second blocking thread.

10. The non-transitory, computer-readable medium of claim 8, wherein before receiving the first prediction and the second prediction from the first trained ML model, the operations further comprise:
determining that a second trained ML model is available for generating the first prediction and the second prediction; and
sending the second trained ML model to the MPSC channel for the first trained ML model hosted on the ML model serving platform to be updated based on the second trained ML model in the MPSC channel.

11. The non-transitory, computer-readable medium of claim 8, wherein after scheduling the first asynchronous RPC and the second asynchronous RPC and before receiving the first prediction and the second prediction, the operations further comprise:
initiating inferencing of the first prediction and the second prediction in the ML model serving platform by sending the first blocking thread and the second blocking thread to a runtime of the ML model serving platform.

12. The non-transitory, computer-readable medium of claim 8, wherein the ML model serving platform comprises a plurality of ML libraries.

13. The non-transitory, computer-readable medium of claim 8, wherein after sending the first asynchronous RPC to the MPSC channel and before executing the second green thread on the OS thread, the operations further comprise:
setting the first green thread to wait status; and
freeing the OS thread.

14. The non-transitory, computer-readable medium of claim 9, wherein retrieving the first asynchronous RPC and the second asynchronous RPC from the MPSC channel comprises retrieving the first asynchronous RPC and the second asynchronous RPC from the MPSC channel using a single-threaded loop, wherein the single-threaded loop comprises one thread for retrieving the first asynchronous RPC and the second asynchronous RPC from the MPSC channel.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, from a first service, a first request for running a first trained machine learning (ML) model to provide a first prediction based on a first plurality of parameters, wherein the first trained ML model is hosted on a ML model serving platform;
generating, responsive to the first request, a first green thread comprising a first remote procedure call (RPC) non-blocking thread;
generating a first asynchronous RPC based on the first request;
sending the first asynchronous RPC to a multiple producer single consumer (MPSC) channel by executing the first green thread on an operating system (OS) thread;
receiving, from a second service, a second request for running the first trained ML model to provide a second prediction based on a second plurality of parameters;
generating, responsive to the second request, a second green thread comprising a second RPC non-blocking thread;
generating a second asynchronous RPC based on the second request;
sending the second asynchronous RPC to the MPSC channel by executing the second green thread on the OS thread;
scheduling, using a first blocking thread and a second blocking thread, the first asynchronous RPC and the second asynchronous RPC;
receiving, from the first trained ML model executed using the first blocking thread and the second blocking thread, the first prediction and the second prediction; and
providing the first prediction to the first service and the second prediction to the second service.

16. The computer-implemented system of claim 15, wherein scheduling the first asynchronous RPC and the second asynchronous RPC comprises:
retrieving the first asynchronous RPC and the second asynchronous RPC from the MPSC channel;
extracting the first plurality of parameters from the retrieved first asynchronous RPC and the second plurality of parameters from the retrieved second asynchronous RPC; and
submitting the extracted first plurality of parameters to the first blocking thread and the extracted second plurality of parameters to the second blocking thread.

17. The computer-implemented system of claim 15, wherein before receiving the first prediction and the second prediction from the first trained ML model, the one or more operations further comprise:
determining that a second trained ML model is available for generating the first prediction and the second prediction; and
sending the second trained ML model to the MPSC channel for the first trained ML model hosted on the ML model serving platform to be updated based on the second trained ML model in the MPSC channel.

18. The computer-implemented system of claim 15, wherein after scheduling the first asynchronous RPC and the second asynchronous RPC and before receiving the first prediction and the second prediction, the one or more operations further comprise:
initiating inferencing of the first prediction and the second prediction in the ML model serving platform by sending the first blocking thread and the second blocking thread to a runtime of the ML model serving platform.

19. The computer-implemented system of claim 15, wherein after sending the first asynchronous RPC to the MPSC channel and before executing the second green thread on the OS thread, the one or more operations further comprise:
setting the first green thread to wait status; and
freeing the OS thread.

20. The computer-implemented system of claim 16, wherein retrieving the first asynchronous RPC and the second asynchronous RPC from the MPSC channel comprises retrieving the first asynchronous RPC and the second asynchronous RPC from the MPSC channel using a single-threaded loop, wherein the single-threaded loop comprises one thread for retrieving the first asynchronous RPC and the second asynchronous RPC from the MPSC channel.
